(19) United States
(12) Patent Application Publication
(10) Pub. No.: US 2011/0128899 A1
(43) Pub. Date: Jun. 2, 2011

(54) ELECTRONIC DEVICE AND POWER SAVING METHOD THEREOF

(75) Inventors: Wei-Ta Su, Taipei City (TW); Hsin-Hung Lin, Taipei City (TW); Der-Chung Hwang, Taipei City (TW); Anhua Tsui, Taipei City (TW); Chieh-Tsao Hwang, Taipei City (TW); Chih-Wei Chang, Taipei City (TW); Jenq-Haur Pan, Taipei City (TW); Shao-Hsien Wang, Taipei City (TW); Chien-Ming Lee, Taipei City (TW)

(73) Assignee: COMPAL ELECTRONICS, INC., Taipei City (TW)

(21) Appl. No.: 12/915,041

(22) Filed: Oct. 29, 2010

Related U.S. Application Data
(60) Provisional application No. 61/265,339, filed on Nov. 30, 2009.

(30) Foreign Application Priority Data
Oct. 5, 2010 (TW) 99133886

(51) Int. Cl. H04W 52/02

(52) U.S. Cl. 370/311

(57) ABSTRACT

An electronic device and a power saving method thereof are provided. The electronic device includes a network module and a power saving module, wherein the network module connects to an access point (AP). The method includes executing an AP search operation at a predetermined time interval by the network module, and determining whether the electronic device is in a specific state by the power saving module. The method also includes disabling the network module from executing the AP search operation as long as the electronic device is still in the specific state. As a result, the unnecessary AP search operations can be avoided, and the purpose of saving power can be achieved.

### CROSS-REFERENCE TO RELATED APPLICATION

This application claims the priority benefit of U.S.A. provisional application Ser. No. 61/265,339, filed on Nov. 30, 2009, all disclosures are incorporated therewith. This application also claims the priority of Taiwan application serial no. 99133886, filed on Oct. 5, 2010. All disclosure of the Taiwan application is incorporated herein by reference.

### BACKGROUND

1. Field of the Invention

The present invention relates to a power saving method of an electronic device, and more particularly to a power saving method of an electronic device having network connection function.

2. Description of Related Art

Along with the rapid advancement of the Internet, the information transmission medium is not limited to newspapers, periodicals and the television media. Nowadays, people may retrieve the required information from a network. People may also use the network to conduct social, recreational or commercial transaction activities. As the wireless network technology continues to improve, the time and place of using a network are no longer being limited as long as the electronic products are capable of connecting to a wireless network.

A wireless network interface card is an indispensable device for an electronic product to connect to a wireless network. According to the standard specifications of local area network, prior to connecting to any access point (AP), it is mandated for the wireless network interface card to execute an AP search operation at a first predetermined time interval (a duration of about 60 second) to identify the AP in the environment that is appropriate for connection. The execution of each AP search operation requires approximately 8 seconds.

After the wireless network interface card connects to an AP, as shown in FIG. 1, the wireless network interface card still executes the AP search operation (for example, the AP search operations 110, 120, 130) at the first predetermined time interval T1 (a duration of about 60 second). Moreover, in order to ensure the wireless network interface card is connected to the AP, the wireless network interface card sends an ACK signal, which uses up about 0.03 second, for every second predetermined time interval (a duration of about 0.1 to 1 second) to the currently connected AP and bases on a beacon correspondingly feedback from the AP.

As shown in FIG. 1, each AP search operation that is being executed after the wireless network interface card is connected to the AP is for the purpose of preventing the wireless network interface card from being disconnected with the currently connected AP due to displacement or other reasons. However, when the connection between the wireless network interface card and the AP is stable, the AP search operation is expendable and undue power consumption is resulted.

### SUMMARY OF THE INVENTION

The present invention is directed to a power saving method in which the electronic device is obviated from any unnecessary access point (AP) search operation to lower power loss.

The present invention provides an electronic device, wherein any unnecessary AP search operation is reduced to improve power saving.

The present invention provides a power saving method, applicable in an electronic device having a network module and a power saving module, wherein the network module connects to an AP. In the method, the network module executes an AP search operation at a predetermined time interval and the power saving module determines whether the electronic device is in a specific state. When the electronic device is/maintains in the specific state, the power saving module disables the network module from executing the AP search operation.

According to an exemplary embodiment of the disclosure, whether the electronic device is in the specific state is determined according to a quality of service between the network module and the AP.

According to an exemplary embodiment of the disclosure, the step of determining whether the electronic device is in the specific state according to the quality of service between the network module and the AP includes: whenever the network module receives a beacon from the AP, a received signal strength indication (RSSI) of the AP is obtained. When the RSSI is greater than a first threshold value, it is determined that the electronic device is in the specific state.

According to the exemplary embodiment of the disclosure, the step of determining whether the electronic device is in the specific state according to the quality of service between the network module and the AP includes: whenever the network module receives a beacon from the AP, a signal to noise rate (SNR) is calculated. When the SNR is greater than a second threshold value, it is determined that the electronic device is in the specific state.

According to an exemplary embodiment of the disclosure, wherein the step of determining whether the electronic device is in the specific state includes when the electronic device enters an idle mode, it is determined that the electronic device is in the specific state.

According to an exemplary embodiment of the disclosure, the power saving method further includes when the electronic device is not in the specific state, the network module is allowed to perform the AP search operation at the predetermined time interval.

From another point of view, an exemplary embodiment of the disclosure provides an electronic device that includes a network module and a power saving module. After the network module connects to an AP, the network module executes an AP search operation at a predetermined time interval. The power saving module is coupled to the network module, and the power saving module serves to determine whether the electronic device is in a specific state. When the electronic device is/maintains in the specific state, the network module is disabled from executing the AP search operation.

According to an exemplary embodiment of the disclosure, wherein the power saving module determines whether the electronic device is in a specific state according to a quality of service between the network module and the AP.

According to an exemplary embodiment of the disclosure, whenever the network module receives a beacon from the AP, the network module also obtains a received signal strength indication of the AP. When the RSSI is greater than a first threshold value, it is determined that the electronic device is in the specific state.

According to an exemplary embodiment of the disclosure, whenever the network module receives a beacon from the AP, the network module calculates a signal to noise rate (SNR) of the AP. When the SNR is greater than a second threshold value, it is determined that the electronic device is in the specific state.

According to an exemplary embodiment of the disclosure, when the electronic device enters an idle mode, the power saving module determines that the electronic device is in the specific state.

According to an exemplary embodiment of the disclosure, when the electronic device is not in the specific state, the power saving module allows the network module to execute the AP search operation at the predetermined time interval.

According to the various exemplary embodiments of the disclosure, after the electronic device is connected to an AP through the network module, it is determined that whether to disable the network module from executing an AP search operation according to the quality of service and/or the usage mode of the electronic device. Hence, any expendable AP search operation is reduced to improve power saving.

In order to the make the aforementioned and other objects, features and advantages of the present invention comprehensible, a preferred embodiment accompanied with figures are described in detail below.

### BRIEF DESCRIPTION OF THE DRAWINGS

FIG. 1 is a schematic diagram illustrating the operation after the wireless network interface card is connected to an access point according to the prior art.

FIG. 2 is a block diagram of an electronic device according to an exemplary embodiment of the disclosure.

FIG. 3 is a flow diagram of steps of an exemplary power saving method according to an embodiment of the disclosure.

FIG. 4 is a flow diagram of steps of an exemplary power saving method according to an embodiment of the disclosure.

FIG. 5 is a flow diagram of steps of an exemplary power saving method according to an embodiment of the disclosure.

FIG. 6 is a flow diagram of steps of an exemplary power saving method according to an embodiment of the disclosure.

FIG. 7 is a schematic diagram showing the operation of the network module after connecting to an access point according to an exemplary embodiment of the disclosure.

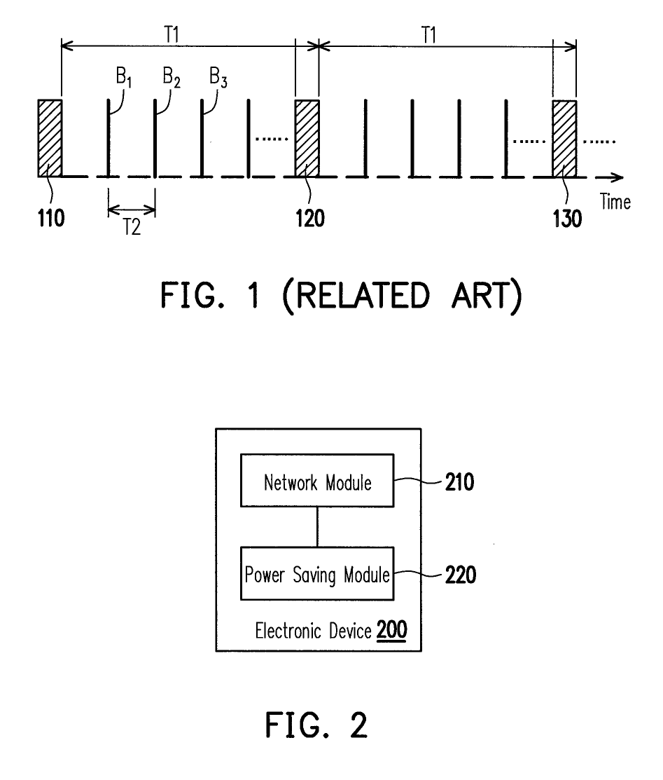

### DESCRIPTION OF EMBODIMENTS

FIG. 2 is a block diagram of an electronic device according to an exemplary embodiment of the disclosure. Referring to FIG. 2, the electronic device 200 includes a network module 210 and a power saving module 220 connected to each other. In this exemplary embodiment, the electronic device 200 may be a notebook computer, a cellular phone, a personal digital assistant (PDA), a PDA cellular phone or other types of smartphones.

The network module 210 includes a wireless network interface card, and the electronic device 200 is connected to an access point (AP) through the network module 210 to access to the wireless network. The wireless network is, for example, a wireless local area network (WLAN).

The power saving module 220, for example, is implemented through a software and/or a hardware device. The power saving module 220 is applied to the electronic device 200 for executing a power saving mechanism. Hence, when the electronic device 220 accesses to a network through the network module 210, unnecessary power loss is reduced. In one exemplary embodiment, when the power saving module is implemented as a software program, this software program is executed directly in/by the operational system of the electronic device 200. In the exemplary embodiment of the invention, the storage device for storing this software is not limited; the software may be stored, for example, in built-in hard disk of the electronic device 200 or externally connected hard disk, etc.

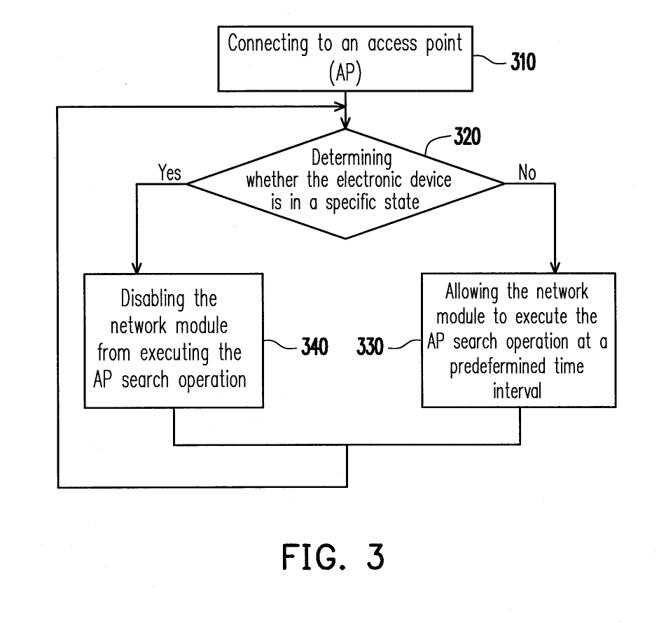

FIG. 3 is a flow diagram of steps of an exemplary power saving method according to an embodiment of the disclosure. FIGS. 2 and 3 describe in details the steps of executing the power saving mechanism to reduce the power loss of the electronic device 200.

After the power of the electronic device 200 is turned on, as shown in step 310, the network module 210 connects to an AP in the environment via the execution of an AP search operation (background scan). Thereafter, in step 320, the power saving module 220 determines whether the electronic device 200 is in a specific state. For example, whether the electronic device 200 is in the specific state is decided by a quality of service between the network module 210 and the AP and/or the usage mode of the electronic device 200. The quality of service may be for example the connection quality between the network module 210 and the AP.

If the electronic device 200 is not in the specific state, as in step 330, the power saving module 220 allows the network module 210 to follow the original wireless network specifications, in which the AP search operation is executed at a predetermined time interval. In contrast, if the electronic device 200 is in the specific state, as in step 340, the power saving module 220 disables the network module 210 from executing the AP search operation.

Generally speaking, the action of the AP search operation is a scan request executed by the module driver of the network module 210 in response to a request sent from the system end (electronic device). When the network module 210 and the AP are connected, and the electronic device 200 is in the specific state, the power saving module 220 makes the module driver of the network module 210 drop/ignore the scan request in order to obviate any excess power consumption. However, the original connection between network module 210 and the AP is not affected by the action of the power saving module 220. In other words, the power saving module disables the AP search operation function of the network module 210.

According to the power saving method in the exemplary embodiment, steps 320 to 340 in FIG. 3 may be continuously repeated. In the mean time, once the electronic device 200 enters and maintains in the specific state, the network module 210 is disabled from executing the AP search operation. In other words, the electronic device 200 may reduce power loss resulted from the execution of the AP search operations. Hence, power saving is achieved.

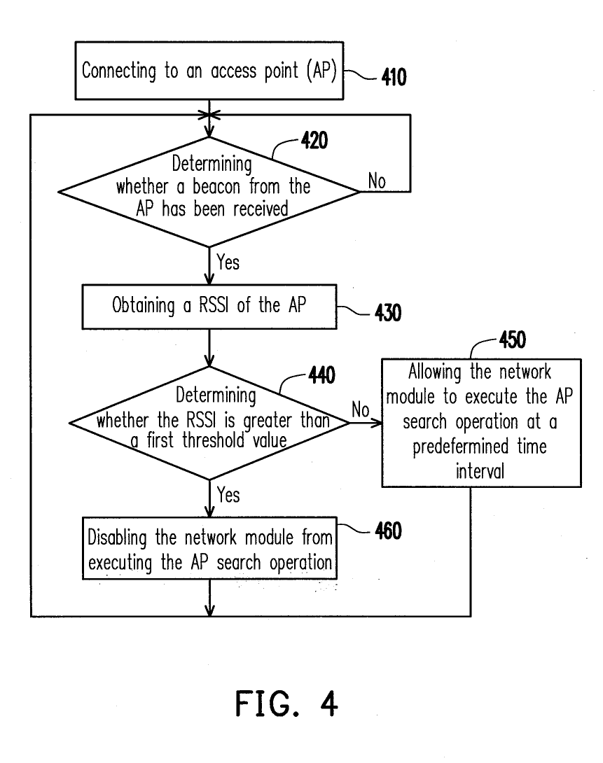

FIG. 4 is a flow diagram of steps of an exemplary power saving method according to an embodiment of the disclosure. In this exemplary embodiment, the power saving module 220 determines whether the electronic device is in a specific state according to a quality of service between the network module 210 and the currently connected AP to decide whether to allow the network module 210 to execute the AP search operation. The quality of service, for example, is represented by a signal strength indication (RSSI) of the AP received by the network module 210.

As shown in FIG. 4, as in step 410, the network module 200 executes an AP search operation and eventually connects to an AP in the environment.

Then, in step 420, the network module 210 repeatedly determines whether a beacon from the currently connected AP has been received. More specifically, after the network module 210 connects to the AP, the network module 210 sends out an ACK signal for approximately every 0.1 to 1 second (it is to be understood that other time duration may be employed without departing from the invention) to ensure the connection is maintained with the AP. Every time the AP receives the ACK signal from the network module 210, a beacon is correspondingly feedback to the network module 210.

After receiving the beacon from the AP, as shown in step 430, the network module 210 obtains the RSSI of the AP based on the beacon. Then, in step 440, the power saving module 220 determines whether the RSSI is greater than a first threshold value. In this exemplary embodiment, the first threshold value is, for example, a value attained by actual measurements through experiments on the operation efficiency of multiple sets of network modules, and further by statistical analysis and experiences, for the value being 15 as an example. It should be noted that the first threshold value may be embodied in many different forms and should not be construed as limited to the embodiments set forth herein.

If the RSSI is less than or equal to the first threshold value, the power saving module 220 determines that the electronic device 200 is not in the specific state. More particularly speaking, the electronic device 200 is about to move away from the AP that the network module 210 is currently connected to, and the network module 210 has the opportunity to search for other AP that could be more appropriate/suitable for connection. As in step 450, the power saving module 220 allows the network module 210 to execute the AP search operation at a predetermined time interval in order to renew the search of AP in the environment.

If the RSSI is greater than the first threshold value, the power saving module 220 determines that the electronic device 200 is in the specific state. Under this situation, the network module 210 maintains in a stable quality of service, for example, the electronic device 200 remains unmoved, and the distance between the electronic device 200 and the currently connected AP is within the vicinity of the preferred signal coverage. Accordingly, the network module 210 is precluded from wasting time in searching for other APs in the environment. Hence, as in step 460, the power saving module 220 disables the network module 210 from executing the AP search operation.

According to the power saving method illustrated in the exemplary embodiment, steps 420 to 460 in FIG. 4 may be continuously repeated. Whenever the RSSI of the currently connected AP is greater than the first threshold value, it is determined that the electronic device 200 is in the specific state, and the network module 210 is forbidden to execute the AP search operation. Once the electronic device 200 is no longer in the specific state, the network module 210 is allowed to execute the AP search operation at the predetermined time interval. Accordingly, the power loss due to the execution of the AP search operation when the electronic device 200 is in the specific state can be mitigated. Moreover, the electronic device 200 is precluded from not being connected to a new AP because the AP search operation is not being executed by the network module 210 due to the disconnection or a poor quality of service with the originally connected AP when the electron device 200 is being moved or because of other reasons.

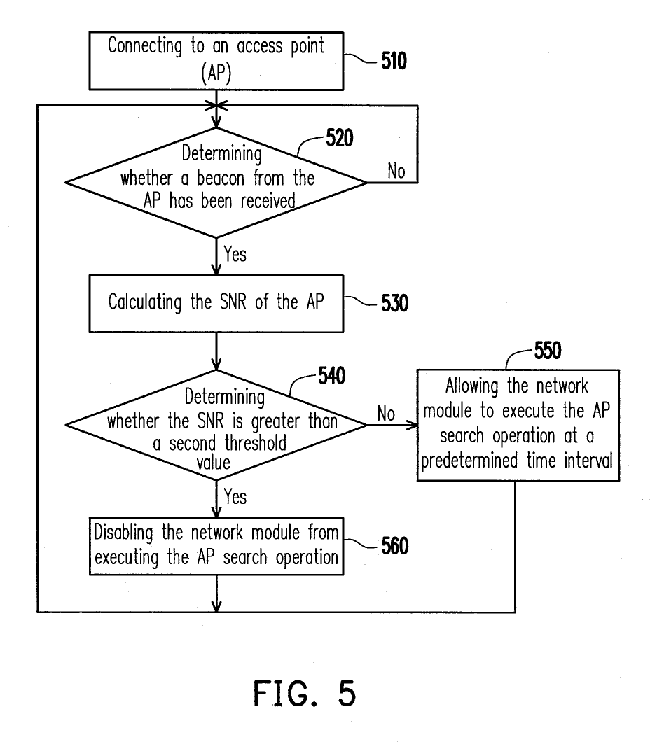

FIG. 5 is a flow diagram of steps of an exemplary power saving method according to an embodiment of the disclosure. The steps in FIGS. 4 and 5 are similar, for example, step 510 and 520 are similar to step 410 and 420; hence, only the differences between the two embodiments are discussed herein.

In this exemplary embodiment, the power saving module 220 determines whether the electronic device 200 is in a specific state according to a quality of service between the network module 210 and the currently connected AP. The quality of service is represented by, for example, the signal to noise rate (SNR).

More specifically, after the network module 210 receives a beacon from the currently connected AP, as in step 530, the network module 210 calculates the SNR of the AP. For example, the network module 200 may receive the RSSI and the noise value generated by the electronic device 200 itself or from an external interference, and the SNR is the ratio of the RSSI and the noise value.

Thereafter, as shown in step 540, the power saving module 220 determines whether the SNR is greater than a second threshold value. The second threshold value is obtainable through actual measurements and statistical methods. The value of the second threshold value should not be limited.

If the SNR is less than or equal to the second threshold value, the power saving module 220 decides that the electronic device 200 is not in a specific state. In contrast, when the SNR is greater than the second threshold value, the power saving module 220 decides that the electronic device 200 is in the specific state, and the power saving module 220 would apply the appropriate actions similar to those previously described and thus will not reiterated herein.

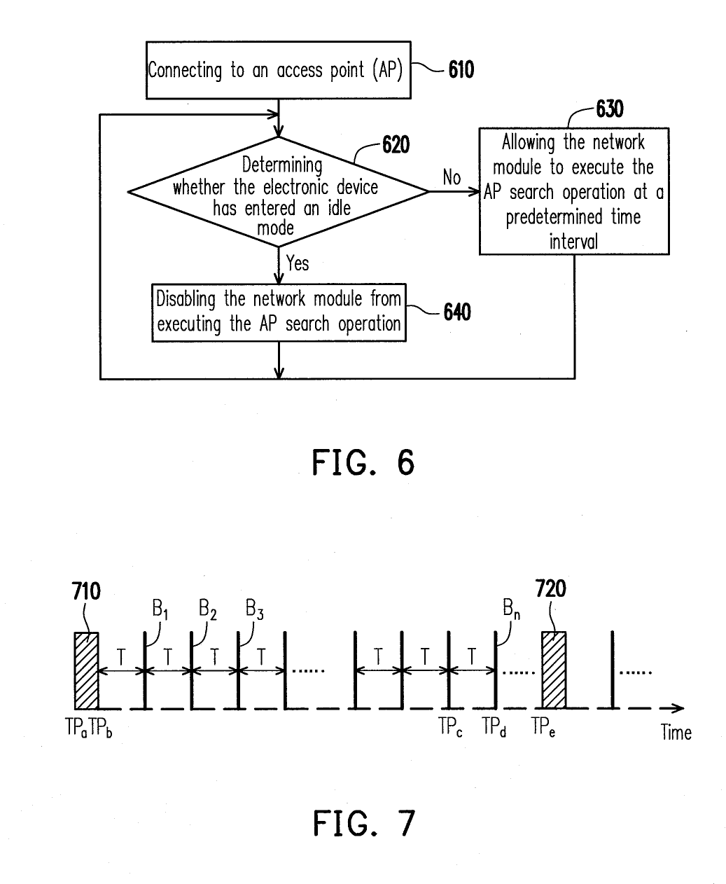

FIG. 6 is a flow diagram of steps of an exemplary power saving method according to an embodiment of the disclosure. In this exemplary embodiment, the power saving module 220 determines whether the electronic device 200 is in a specific state according to the usage mode of the electronic device 200.

As shown in step 610, the network module 210 executes the AP search operation to connect to an AP. Then, in step 620, the power saving module 220 determines whether the electronic device 200 has entered an idle mode. The idle mode is, for example, any mode that ceases the power provision to a part of the electronic device 200. It should be noted that definition of an idle mode corresponds to the type of electronic device 200 and should not be construed as limited to the embodiments set forth herein.

If the electronic device has not entered the idle mode, the power saving module 220 determines that the electronic device 200 is not in the specific state. Then, as shown in step 630, the power saving module 220 allows the network module 210 to execute the AP search operation at a predetermined time interval to renew the search for an appropriate AP in the environment.

As the electronic device 200 enters the idle mode, the power saving module 220 decides that the electronic device 200 is in the specific state. Hence, as in step 640, the power saving module 220 disables the network module 210 from executing the AP search operation.

Since under most situations, the electronic device 200 entering the idle mode indicates that the user is not operating the electronic device 200. Accordingly, the power saving module 220 may disable the network module 210 to execute the AP search operation to reduce power loss.

It is worthy to note that, in the above exemplary embodiments, although determining whether the electronic device is in a specific state is based on the value of the RSSI, the value of the SNR, and whether the electronic device 200 has entered the idle mode, the combinations of the above-mentioned factors may be used to determine whether the electronic device 200 is in the specific state in other exemplary embodiments.

For example, when the electronic device 200 has been determined of entering the idle mode, the power saving module 220 disables the network module 210 from executing the AP search operation. After the electronic device 200 has been determined of resuming to a working mode (such as, receiving an output signal of a mouse, a touch panel or a key board type of output apparatus, or a connection between an external device and the electronic device 200), the power saving module 220 decides whether to disable the network module 210 from executing the AP search operation further according to the value of the obtained RSSI and/or the SNR.

FIG. 7 is a schematic diagram showing the operation of the network module after connecting to an AP according to an exemplary embodiment of the disclosure. In an exemplary embodiment, the network module in the electronic device executes an AP search operation 710 from the time point TPₐ to the time point TP_{b} to connect to an AP. Thereafter, the network module sends out an ACK signal (for example, ACK signal B₁, B₂, B₃, . . . , Bₙ) for every time period T to the currently connected AP, and the AP would feedback a corresponding beacon (not shown) to the electronic device. As shown in FIG. 7, assuming the electron device maintains in the specific state (for example, the RSSI and/or the SNR of the currently connected AP are greater than the corresponding threshold values) during the time point TP_{b} to the time point TP_{c}, the network module would not execute any AP search operation. Hence, power loss is mitigated and the goal of power saving is accomplished.

While at the time point TP_{d}, the network module sends an ACK signal Bₙ, to the currently connected AP and obtains a RSSI and/or a SNR according to a beacon correspondingly feedback from the AP. Assuming the power saving module in the electronic device has determined the RSSI and/or the SNR not being higher than the corresponding threshold value, the power saving module immediately decides that the electronic device has departed from the specific state. Hence, the network module would execute the AP search operation 720 when reaching the predetermined time interval (for example, at the time point TPₑ) to search for a more appropriate AP for connection.

According to the electronic device and the power saving method of the exemplary embodiments of the disclosure, when the electronic device is in a specific state, the network module in the electronic device is disabled from executing an AP search operation to reduce the power loss. Consequently, power saving is achieved by not executing any unnecessary AP search operation when the electronic device has a desirable quality of service and/or enters an idle mode.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A power saving method, applicable for an electronic device comprising a network module and a power saving module, wherein the network module connects to an access point (AP), the method comprising:
executing an AP search operation, by the network module, at a predetermined time interval;
determining, by the power saving module, whether the electronic device is in a specific state; and
when the electronic device is in the specific state, the power saving module disabling the network module from executing the AP search operation.

2. The method of claim 1, wherein the step of determining whether the electronic device is in the specific state is according to a quality of service between the network module and the AP.

3. The method of claim 2, wherein the step of determining whether the electronic device is in the specific state according to the quality of service comprises:
obtaining a received signal strength indication (RSSI) of the AP whenever the network module receives a beacon from the AP; and
deciding the electronic device is in the specific state when the RSSI is greater than a first threshold value.

4. The method of claim 2, wherein the step of determining whether the electronic device is in the specific state according to the quality of service comprises:
calculating a signal to noise rate (SNR) of the AP whenever the network module receives a beacon from the AP; and
deciding the electronic device is in the specific state when the SNR is greater than a second threshold value.

5. The method of claim 1, wherein the step of determining whether the electronic device is in the specific state comprises:
deciding the electronic device is in the specific state when the electronic device enters an idle mode.

6. The method of claim 1 further comprising:
allowing the network module to execute the AP search operation at the predetermined time interval when the electronic device is not in the specific state.

7. An electronic device, comprising:
a network module for executing an AP search operation at a predetermined time interval after the network module connects to an AP; and
a power saving module, coupled to the network module, the power saving module determining whether the electronic device is in a specific state, and disabling the network module from executing the AP search operation when the electronic device is in the specific state.

8. The electronic device of claim 7, wherein the power saving module determines whether the electronic device is in the specific state according to a quality of service between the network module and the AP.

9. The electronic device of claim 7, wherein whenever the network module receives a beacon from the AP, the network module obtains a received signal strength indication (RSSI) of the AP, and the power saving module decides the electronic device is in the specific state when the RSSI is greater than a first threshold value.

10. The electronic device of claim 7, wherein whenever the network module receives a beacon from the AP, the network module calculates a signal to noise rate (SNR) of the AP, and the power saving module decides the electronic device is in the specific state when the RSSI is greater than a second threshold value.

11. The electronic device of claim 7, wherein the power saving module decides that the electronic device is in the specific state when the electronic device enters an idle mode.

12. The electronic device of claim 7, wherein the power saving module allows the network module to execute the AP search operation at the predetermined time interval when the electronic device is not in the specific state.
